(19) United States
(12) Patent Application Publication
(10) Pub. No.: US 2007/0288302 A1
(43) Pub. Date: Dec. 13, 2007

(54) Donation Pages for an On-Line Campaign Management

(76) Inventors: Ravneet Singh, Naperville, IL (US); Simerneet Singh, Chicago, IL (US)

Correspondence Address: CARDINAL LAW GROUP, Suite 2000, 1603 Orrington Avenue, Evanston, IL, 60201, US

(21) Appl. No.: 11/761,933

(22) Filed: Jun. 12, 2007

Related U.S. Application Data
(60) Provisional application No. 60/812,852, filed on Jun. 12, 2006.

(51) Int. Cl. G06Q 10/00

(52) U.S. Cl. 705/10

(57) ABSTRACT

A method for facilitating communication between a candidate and at least one voter includes receiving at least one communication between the candidate and at least one voter, determining at least one jurisdiction for the communication between the candidate and voter, accessing a compliance database based on the determined jurisdiction, determining at least one compliance rule responsive to the accessing, comparing the received communication and compliance rule, and facilitating the transmission of the communication between the candidate and at least one voter based on the comparison.

### RELATED APPLICATIONS

This application claims the benefit of and priority to U.S. Provisional Patent Application 60/812,852 filed Jun. 12, 2006.

### FIELD OF THE INVENTION

The present invention relates to solutions for elections and campaigns. The present invention generally relates to access to and maintenance of various enrolled Internet services and purchased Internet tools for elections and campaigns, including supporter donations.

### BACKGROUND OF THE INVENTION

The democratic process relies on campaigns by politicians seeking political office. Politicians (or candidates) need to reach voters to participate in the process, and voters need to reach politicians to make an educated determination for the voters vote. Bringing candidates to voters, and voters to candidates, is the goal. Politicians (or candidates) need to reach voters and donors to participate in the process, and voters/donors need to reach politicians to make an educated determination for the voters vote and/or contribution. Bringing candidates to voters and donors, and voters and donors to candidates, is the goal. Throughout this document, we do not distinguish between voters and donors.

However, the multitude of candidates for each office, and the multitude of offices makes this participation unwieldy and difficult to manage. Not only are the logistics of such communication difficult, a multitude of laws and regulations govern communications between candidates and voters, and these laws and regulations vary based on geography, political subdivisions, office, and time, among others.

It is therefore desirable to advance the state of the art of political communications to facilitate communication between candidates and voters.

### SUMMARY OF THE INVENTION

The present invention provides a new and unique donation pages for providing a website application for campaigns and elections with a built-in leader program that ranks contributions and provides incentives.

One aspect of the invention provides a method for facilitating communication between a candidate and at least one voter that includes receiving at least one communication between the candidate and at least one voter, determining at least one jurisdiction for the communication between the candidate and voter, accessing a compliance database based on the determined jurisdiction, determining at least one compliance rule responsive to the accessing, comparing the received communication and compliance rule, and facilitating the transmission of the communication between the candidate and at least one voter based on the comparison.

A second aspect of the invention provides a method for facilitating donations from voters to campaigns. The method includes establishing a campaign promoting the candidate for at least one office, determining at least one leader for the campaign, receiving at least one communication to at least one voter from the leader, and facilitating at least one donation from the voter to the campaign.

Another aspect of the invention is a method for generating a dynamic web page. The method includes receiving a page request, determining at least one jurisdiction based on the page request, accessing a compliance database based on the determined jurisdiction, determining at least one compliance rule responsive to the accessing, comparing the received communication and compliance rule, and generating the dynamic web page based on the determined compliance rule.

Yet another aspect of the invention provides a method for collecting campaign donations for a campaign in a jurisdiction. The method includes receiving a first donation from a voter, determining the amount of the first donation, determining a maximum donation amount based on the jurisdiction, comparing the determined amount to the determined maximum donation, accepting the first donation when the determined amount is less than the determined maximum donation, receiving a second donation from the voter, determining an amount of the second donation, comparing a sum of the amount of the first donation and the amount of the second donation to the determined maximum donation, and accepting the second donation with the sum is less than the determined maximum donation.

### BRIEF DESCRIPTION OF THE DRAWINGS

FIG. 1 illustrates one embodiment of a method for facilitating communication in accordance with one aspect of the invention;

FIG. 2 illustrates one embodiment of a method for facilitating donations in accordance with one aspect of the invention;

FIG. 3 illustrates one embodiment of a method for generating a dynamic web page, in accordance with one aspect of the invention;

FIG. 4 illustrates one embodiment of a method for collecting campaign donations in accordance with another aspect of the invention; and

FIG. 5 illustrates one embodiment of architecture for a central location, in accordance with one aspect of the invention.

### DETAILED DESCRIPTION OF THE INVENTION

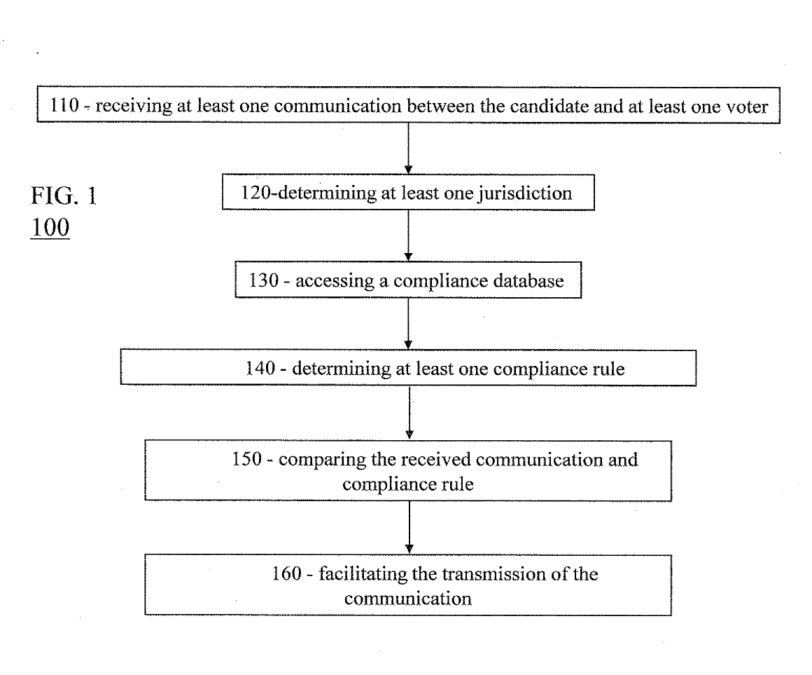

FIG. 1 illustrates one embodiment of a method for facilitating communication between a candidate and at least one voter, in accordance with one aspect of the invention. Method 100 begins at step 110 by receiving at least one communication between the candidate and the at least one voter. In one embodiment, the communication is received at a central location, such as a website, via a network. The network can be any networked system, such as a packet data network. In one embodiment, the network is the Internet. The central location can be geographically centralized, or geographically dispersed. The central location can be a single server or a group of discrete servers geographically centralized or dispersed across a wide geographic area. As used herein, the term “voter” is defined as any person with the right or ability to vote, including people who do and do not actually cast a ballot in an election, as well as persons who are eligible to participate in the political process, including voters, constituents, election consultants, and volunteers.

The communication can be an email, instant message, text message or any other discrete or continuous flow of data. In one embodiment, the communication is from the voter to the candidate. In another embodiment, the communication is from the candidate to the voter. In other embodiments, the communication is from the candidate to a plurality of voters.

Method 100 further determines, at step 120, at least one jurisdiction for the communication. In one embodiment, the jurisdiction is associated with the candidate. In another embodiment, the jurisdiction is associated with the voter. In another embodiment, the jurisdiction is associated with the office sought by the candidate. In another embodiment, the jurisdiction is determined in response to a query directed to either the candidate or voter, or both. The jurisdiction is, in another embodiment, associated with the office sought by the candidate. Each jurisdiction is further associated with a number N, wherein N≧0, of laws and/or regulations controlling or governing communications between candidates and voters. In one embodiment, the jurisdiction is determined based on a received IP address.

A compliance database, storing the N laws, is accessed at step 130, and any compliance rules based on the determined jurisdiction are determined at step 140. The compliance database is any database, such as a relational database or other data storage system, maintains associations between jurisdictions and the laws or regulations applicable to communications between voters and candidates. These laws or regulations are expressed as compliance rules, enabling the communication to comply with the laws. In one embodiment, the compliance rules are maintained in the compliance database. In another embodiment, the compliance database does not store at least one compliance rule for the determined database, and the voter and/or candidate are prompted to provide the compliance rule. Based on the prompt, the compliance rule is then added to the compliance database, in one embodiment. In one embodiment, the received compliance rule is checked for accuracy prior to insertion in the compliance database. In one embodiment, the method determines whether the compliance database includes at least one entry for the determined jurisdiction and establishes the compliance rule based on the entry, if at least one entry exists, and requests entry of at least one compliance rule, if at least one entry does not exist in the compliance database.

In one embodiment, a compliance rule mandates communications of certain messages, such as a compliance message in all communications between voters and candidates. In one such embodiment, the compliance message is then appended in an appropriate position (such as the beginning or end of the communications) to the communication.

Having determined the compliance rules, the compliance rules are compared to the received communication at step 150. Based on the comparison, the communication between the candidate and voter is facilitated at step 160. For example, if a compliance rule mandates that the communication include a compliance message (such as a certain text paragraph or disclaimer), and the communication does not already include the disclaimer, the central location appends the compliance message to the communication, and then transmits the communication from the sender (either the voter or candidate) to the recipient (the other of the voter and candidate). In one embodiment, the transmission of the message is precluded based on the IP address. In another embodiment, the transmission is assisted based on the IP address. In one embodiment, the IP address is compared with a list of IP addresses to determine an appropriate address.

In one embodiment, the central location further determines at least one leader associated with the voter and candidate based on receiving the communication. Having determined the leader, someone who gives and raises money while doing advocacy on behalf of the campaign on a volunteer basis, the method then, the method then notifies the leader based on the facilitation of the communication. In one embodiment, communications between voters associated with a leader and the campaign are routed through the leader. In one embodiment, each leader receives a splash web page created by the central location for the leaders to amend to promote campaign issues, donations and fundraisers, or the like. In some embodiments, the leader has the ability to schedule events, set donation amounts, create promotional materials, communicate with campaign headquarters, send emails to voters, send text messages to voters, send ‘snail’ mail to voters or the like. In one embodiment, each leader can upload a logo (such as a .jpeg or .tiff), and each communication to and from the leader features the uploaded logo. In one embodiment, actions taken by the leader (such as fundraisers, promotional material, etc.) must be approved by the campaign prior to transmission to a voter. In one embodiment, the leader is granted access to media databases for use in promotional efforts. In one embodiment, access to the media database can be limited to certain subsets of the media database responsive to at least one demographic characteristic. The demographic characteristics can include geography, race, donations, and the like.

In another embodiment, the communication relates to the purchase of tickets to a fundraiser. In such an embodiment, the central location receives a request to create the fundraiser, such as from a leader or a candidate. After creating the fundraiser, the central location receives a request to attend the fundraiser from at least one voter, issues tickets based on the request, and receives payments or donations from the voter in exchange for the tickets. In one embodiment, the central location then levies a commission against the payments or donations, and sends the remaining monies to the candidate. The commission can be determined as a fixed rate, variable rate, percentage, or other basis for commission. The commission can be determined dynamically based on ticket price, in one embodiment. In another embodiment, the commission is determined on a staggered basis, such as 5% of the first $100, 4% of the second $100, and 2% of amounts over $200, or other schemes. In another embodiment, the commission is levied against a total amount of funds raised rather than against a particular donation. In other embodiments, a flat fee is levied against the campaign, rather than a commission.

In other embodiments, the commission is variable responsive to a type of fundraiser. For example, a first commission rate is assessed against donations for a candidate dinner, a second commission rate is assessed against donations for a candidate coffee, and the like. In yet other embodiments, a maximum commission level is set such that all commissions collected across all donations are less than or equal to a certain maximum commission level. In yet other embodiments, a minimum commission level is set such that all donations across all donation sources are maintained by the central location up to the certain minimum commission level, while all donations over the minimum commission level are directed to the campaign without commission charge.

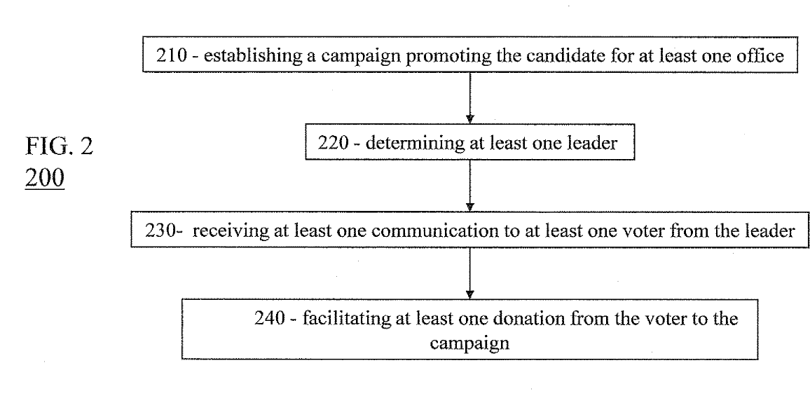

FIG. 2 illustrates one embodiment of a method 200 for facilitating donations from voters to campaigns in accordance with another aspect of the invention. Method 200 begins at 210 by establishing a campaign promoting a candidate for at least one office. The office can be any democratically elected office. At least one leader for the campaign is determined at step 220. The leader is a person who is taking the lead on at least one aspect of the campaign, such as fundraising and/or promotion and/or Get Out The Vote (“GOTV”). The leader can be an employee of the campaign, or a volunteer. The central location receives at least one communication to at least one voter from the leader at step 230. The communication can relate to any of the tasks assumed by the leader, including fundraising, promotion, and/or GOTV. Having received the communication from the leader, the central location then facilitates at least one donation from the voter to the campaign at step 240. In one embodiment, facilitating the donation includes executing method 100 described above.

In one embodiment, the facilitated donation is associated with the leader, and a point value is assigned to the facilitated donation. In another embodiment, the facilitated donation is associated with the voter, and a point value is assigned to the facilitated donation. Having associated with facilitated donation with either the leader or the voter, or both, the central location receives a request for at least one item based on a sum of assigned point values associated with the leader and/or voter, and provides at least one item to the leader and/or voter based on the request and the sum of the assigned point values associated with the leader and/or voter. In one embodiment, points are assigned to multiple levels of leaders so that a leader can accumulate additional points by recruiting downstream leaders, creating a hierarchal system with built-in incentives. In one embodiment, the central location ensures compliance with at least one compliance rule prior to providing the item to the leader. For example, all items are provided with a disclaimer illustrating the entity that paid for the item, in one embodiment. In one embodiment, the superadministrator has the ability to review all items provided to leaders. In another embodiment, the superadministrator includes an accounting report to a candidate based on the provision of items to leaders. For example, based on the point total, a leader can receive tickets to an event, cash, banners, t-shirts, mugs, pins, posters, personal phone calls from the candidate, or other items of value. In one embodiment, any item provided to a leader is referenced against the compliance database to ensure that the provision of the item to a fundraiser is in compliance with rules.

In one embodiment, different levels of contributions trigger various commissions on the fundraising for payment to the leader. For example, a leader receives a commission of 1% of the first $10,000 raised, 5% of the next $100,000, and so on. In other examples, the leader receives a flat commission rate. In yet other examples, the leader receives a flat payment for fundraising efforts.

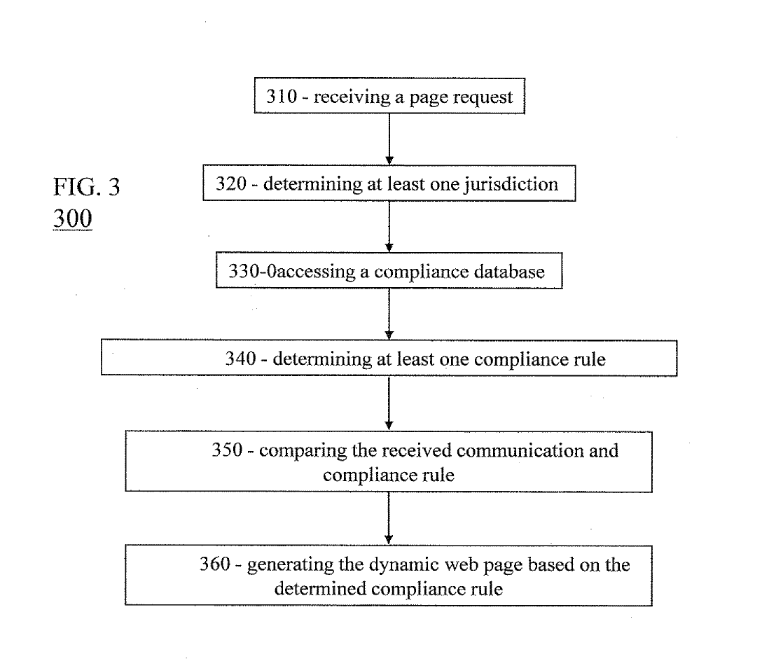

FIG. 3 illustrates one embodiment of a method 300 for generating a dynamic web page, in accordance with one aspect of the invention. Method 300 begins at step 310 by receiving a page request. In one embodiment, the page request is received at a central location. In one embodiment, the page request is received via a network, such as a packet data network. In one embodiment, the page request is received over the Internet.

After receiving the page request, method 300 determines at least one jurisdiction based on the page request at step 320. The jurisdiction can be determined in response to a manual input, a predetermined input, a geolocation input determined in response to at least one network address (such as an IP address), or based on the office sought by the candidate. In one embodiment, the jurisdiction is determined when the dynamic web page is created. Based on the determined jurisdiction, a compliance database is accessed at step 330, and at least one compliance rule is determined responsive to the accessing of the compliance database at step 340. In one embodiment, the compliance database is similar to the database described with reference to method 100.

Method 300 continues by comparing the received communication and compliance rule at step 350. In one embodiment, the comparison is similar to the comparison made in step 150 of method 100. Based on the comparison, a dynamic web page is created. In one embodiment, the dynamic web page is based on the determined compliance rule.

For example, in certain jurisdictions, communications between candidates and voters are required to feature a disclaimer. When setting up the dynamic web page, the central location leaves a portion of the dynamic web page to be dynamically loaded with the disclaimer based on the determined jurisdiction after the page request is received. Any other appropriate compliance rule can be used. Using the disclosures herein, those of ordinary skill in the art will recognize the ability to set up campaign web pages in an automated fashion, and without manual intervention from the central location, while ensuring that the campaign web page will dynamically comply with any restrictions on its content required by compliance rules established by the jurisdiction. Those of skill in the art will further recognize the advantages attendant in setting up and maintaining a database of compliance rules to enable the creation of compliant web pages dynamically.

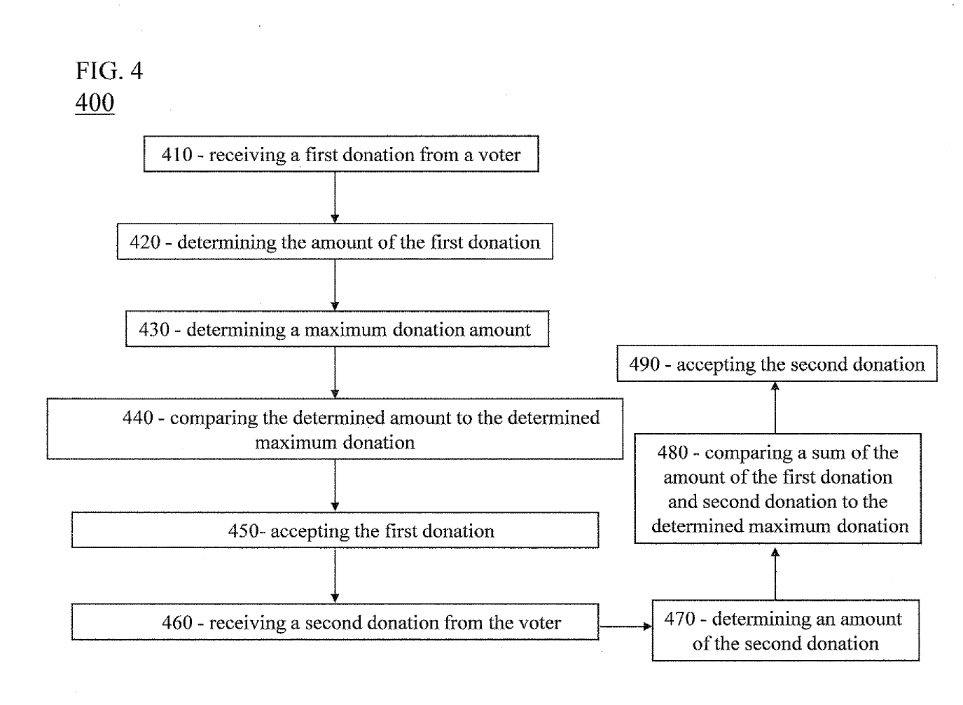

FIG. 4 illustrates one embodiment of a method 400 for collecting campaign donations for a campaign in a jurisdiction, in accordance with one aspect of the invention. The donations can be general donations, or donations for certain events, such as fundraiser events, items promoting political causes, or the like. Method 400 begins by receiving a first donation from a voter at step 410. In one embodiment, the donation is received via a network, such as a packet data network, such as the Internet. In one embodiment, the donation is received at a central location, such as a website. The donation, in one embodiment, is received directly from a voter. In another embodiment, the donation is received from the voter via at least one leader. Having received the first donation, method 400 determines the amount of the first donation at step 420. At step 430, a maximum donation amount based on the jurisdiction is determined. Certain jurisdictions limit donations to campaigns by a single voter to a certain predefined maximum donation amount. For example, in 2007, Americans were precluded from donating more than $2000 to any candidate or campaign.

After determining the amount of the first donation and the maximum donation amount, method 400 compares the determined amount to the determined maximum donation at step 440. Based on the comparison, at step 450, the first donation is accepted when the determined amount is less than the determined maximum donation. In one embodiment, the first donation is rejected if more than the determined maximum donation.

At step 460, a second donation is received from the voter. In one embodiment, the second donation is received in the same or similar fashion as the first donation. An amount of the second donation is determined at step 470, and the sum of the amount of the first donation and the amount of the second donation is compared to the determined maximum donation at step 480. Based on the comparison, the second donation is accepted if the sum is less than the determined maximum donation at step 490.

In one embodiment, a donation database, such as a database controlled by the entity charged with monitoring donations, is accessed to determine an amount of prior donations by the voter making the first and/or second donations. In such embodiments, the total amount of prior donations is added to the first donation prior to the comparison to ensure that the campaign is not accepting funds from voters who are ineligible to contribute.

In one embodiment, at least one message is transmitted to one or both of the voter and a leader based on accepting at least one of the first donation and second donation. In one embodiment, at least one message is transmitted to one or both of the voter and a leader based on rejecting at least one of the first donation and second donation. In one embodiment, the message explains why the first donation or second donation was rejected by the campaign. In one embodiment, the message displays the determined maximum donation and notifies the voter that the total amount of donations is less than the determined maximum donation. In one embodiment, the message displays the determined maximum donation and notifies the voter that the total amount of donations is the determined maximum donation. In one embodiment, radio buttons are used to inform voters of the opportunity to donate additional amounts of money. In other embodiments, voters who have donated the maximum amount to a single campaign is offered the ability to donate additional money to similar candidates, presuming such donation is allowable by the jurisdictions affected. In one embodiment, a superadministrator monitors donations by each voter to all candidates and compares the amounts donated to all candidates.

In another embodiment, the central location determines at least one IP address associated with each donation, and compares the determined IP address to determine whether to accept the donation or to reject the donation. For example, a candidate may wish to reject donations from certain geographic regions (such as out of state). In such embodiments, the IP address can be compared to geographic maps of IP addresses, and donations refused from IP addresses. Alternatively, only donations with certain IP address will be accepted in other embodiments.

In one embodiment, voters are provided the opportunity to set up periodic donations. In such embodiments, the voter defines an amount of money and an interval between donations. For example, a voter can donate $50 every other Friday. In another embodiment, the voter can donate $100 on the 1st of each month. In one embodiment, the central location tracks each donation, compares the total donated amount to the maximum donation and only accepts the donation if the total donated amount is less than the maximum donation.

In another embodiment, voters are provided the opportunity to select from a plurality of funds associated with the candidate. For example, the voter can be allowed to provide a maximum donation to the candidate, as well as maximum donations to local political parties along with a suggestion on a recipient for the donation. In one embodiment, a candidate can set up a plurality of special interest funds, and each special interest fund can receive the maximum donation from the voter.

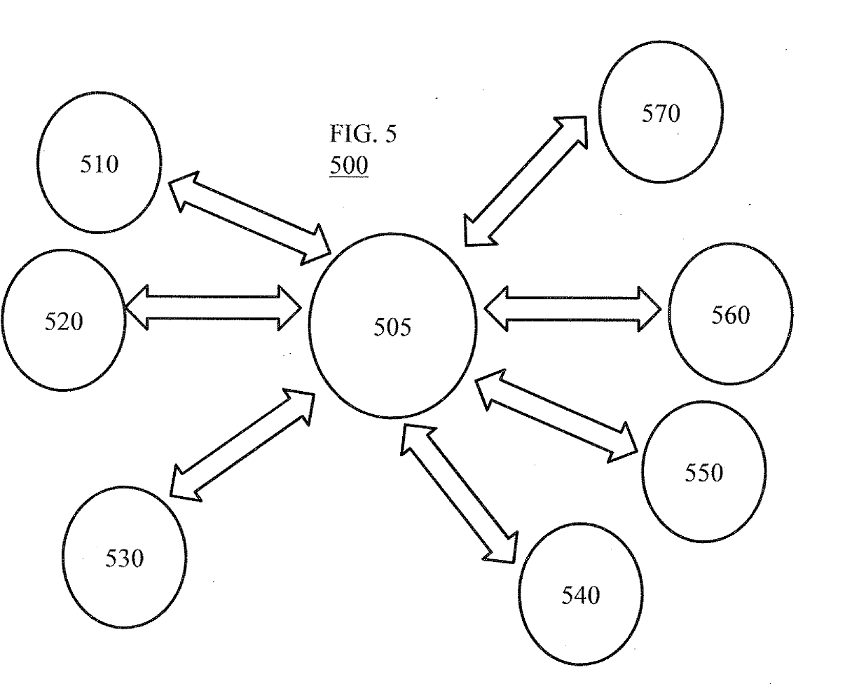

FIG. 5 illustrates one embodiment of architecture 500 for a central location, in accordance with one aspect of the invention. Architecture 500 includes a central engine 505, in communication with a donation page 510, a thank you card engine 520, a printable photo application 530, a donation store 540, a monthly contribution engine 550, a ticket engine 560 and a leader administration application 570.

In one embodiment, a superadministrator has privileges to review and/or modify all data across all candidates. In one embodiment, the superadministrator has the ability to execute certain bookkeeping processes on the data. In another embodiment, the superadministrator has the ability to compare all data to the compliance rules, and to take certain actions based on the comparison.

In one embodiment, the central location sets up demo accounts to illustrate at least one of the features described herein. The demo account can be full featured or only offer certain subsets of the full feature. The demo account, in certain embodiments, is accessible to the public, while the demo account is unavailable to the public in certain embodiments. In one embodiment, the demo account is valid for a predetermined time period, while in other embodiments, the demo account is valid until deleted by either the campaign or the superadministrator or by a data retention policy. In one embodiment, the creation of a demo account is associated with the creation of a transmitted email preferring the recipient the opportunity to review the demo account, accept a paid account, or to delete the demo account.

In one embodiment, a voter can search for a political event, such as a fundraiser, within a certain geographic area. The geographic area can be determined based on an input from the voter, or in response to an IP address. In one embodiment, the IP address is used to confirm the voters location. In one embodiment, the search is limited to a particular candidate, while in other embodiments, the search can cover all candidates for all offices.

In one embodiment, the central location tracks donations by each voter in total over a period of time. Many times donors do not have the ability to find where or how much they have given to a campaign because the responsibility lies on the campaign side. While campaigns must report donations to an appropriate commission or state governing body, voters need not report their donations. Even then these disclosures are timely and have certain restrictions on limited information for example employer information and amount and address. Donors are unable to find out how much they have given to an elected official or multiple officials. In accordance with aspect of the invention, the central location allows aggregation of multiple contributions in one central location from different candidates, parties, and locations at various times during the election process. The aggregation can be implemented using appropriate tools, such as hard copy, RSS, email, databases, or the like. In other embodiments, the central location also allows those campaigns that are residing in their system to be able to collect that information in a separate database and allow that specific donor to access her profile information, such as how much gave, when, to whom, how many candidates, donor profile, donor credit ranking, or the like.

In one embodiment, this information is collected in real time allowing the donor to create a login of their own known as a “e-Donor.” This e-donors information is electronically collected from all users of the central location and includes candidate's information and then aggregated in an access from one central login. Thus, multiple campaigns running at various times are accessible on the same platform via the superadministrator. For example, one embodiment of a system at the central location allows aggregation of all campaign donor information into one pool from the campaign side. Further, in certain embodiments, the central location also collects information from the appropriate state filing information or election bodies that collect the information from every federal, state, county, and local municipal election.

In one embodiment, the system monitors the compliance with appropriate laws. In jurisdictions that require campaigns to comply, while imposing little burden on the voter, the monitoring provides compliance reports to assist the campaign in compliance. In one embodiment, a calculator can then determine inform a donor if he or she can give more or less money to a campaign and be compliant with current state laws. For example, differing laws in differing jurisdictions render these laws are complex and not readily available. In one embodiment, the voter can determine a total amount he she can give to a Presidential candidate and then to their local alderman. This ability to validate amounts will allow donors to maximize their contributions and also help the democratic election system be compliant to the laws set by legislatures or other controlling legal body.

In one embodiment, the central location provides for the creation of donor reports indicating the source of money and a validation of the authenticity of the information. In one embodiment, the central location is accessible governing bodies so that the governing body can access by hard copy, email, rss, or appropriate databases to verify reported information. This will provide another validation that the compliance is being done properly not from just the candidate but from the donor.

In one embodiment, e-Donors will be able to login and update their information and provide party affiliation, income status and other information at their own disclosure. They will be able to see if their “return on donation” from each campaign political or non political has been yielded returns by victory in election or the success of some ballot initiative. The ability to combine public access databases to incorporate in the system will allow other third parties to have more accurate donors to target who give and wish to continue to give for any campaign.

In one embodiment, accepting local contributions is preferred than outside or even internally. In one example, the central location will track IP address of where donors are coming from and/or where contributions are made. In one embodiment, this information is cross referenced with email databases of authenticity of the email registration. In other embodiments, additional information is further cross-reference, such as banking information and credit card history. In one embodiment, validation of multiple types of donor information from multiple databases increases the certainty that the voter is certified to give and one of high ranking. In one embodiment, the central location applies a ranking, such as a star ranking to each voter. For example, one voter can receive a five star or 4 star or 3 star ranking based on determining the donor donation amounts, contribution patterns, or similar criteria.

In one embodiment, the system benefits the campaigns, governments, and donors because campaigns can get more donor information, targeted and accurate, governments can validate filings, and information submitted from campaign, and donors can keep track of who they give and be able to give to campaigns on a more consistence basis, finding those campaigns that appeal to them based on profiles in the directory, as well as those that are producing win ratios for them via a “scoreboard” component that tracks the success of campaigns that the donor contributes to in the e-donor program and lastly by calculating their maximums they can give without requiring knowledge of all the federal, state and local and municipal laws.

In one embodiment, the central location allows a user to access this donor information via a login and the software collects the information from multiple databases. In one embodiment, the central location calculates these business logic to make accessible to both the campaign, donor and government entities. This logic is administrated by a superadministrator access that can update this information manually or electronically. This information is monitored and submitted so that information is updated the donor will be notified in real time, the campaign will be notified, or the government agency that is access our data.

In one embodiment, the donor can select or deselect information they wish to disclose or not disclose to the campaign or government. In another embodiment, the superadministrator can create accounts and delete information and keep tracks of history of calculations that are being done by the donors. The superadministrator can notify the campaign of the interest by the donor to possible give. In one embodiment, the restrictions on amount, compliance, or other information are sent to the campaign based on an expression of interest. For example, a campaign may be faced with certain election dates and timelines and filing periods and since campaigns are not only wishing to collect money but also number of donors is a sign of support.

In one embodiment, the central location further includes a “consultant module” to allow multiple campaign supporters to participate in the process of raising funds. These funds can be marketed by them by email, paper, text message, etc. In one embodiment, the consultant is given the ability to assign values of reward by commission or points that can be redeemed for certain campaign giveaways or promotional items. In one embodiment, the central location tracks the compliance, the eligibility, the legal and donor profile information with process any contributions received in the form of monetary or other and then validate the contribution. Upon validation, the campaign receives the funds in a time set out by the donor. In addition, once the central location validates the information, the central location can issue out rewards and commissions or points to the consultant and compensate the consultant, such as through a special login or email in which they will know that they have received it. In one embodiment, payments to the consultant are verified by comparisons to the compliance database prior to issuing the payments. In one embodiment, the consultant can see the information they have trigged in the CENTRAL LOCATION by open rate of email, the email receiving data, or even if a credit card or some other monetary payment has been made via check etc. In one embodiment, a method of tabulating in a point system, all donations and sign-ups for new participants resulting from a leader's effort are tracked and points are given for both financial and non-financial gains for campaigns

In another embodiment a donor charting module provides users to view their donor/leader data on a variety of jurisdictional levels, such as national, state, county, city, or the like. For example, in one embodiment a user will be able to view how many contributors came from Los Angeles County as well as the total contribution dollars from that county. In another embodiment, the same will apply on a statewide level for larger campaigns.

In another embodiment, the central location provides for a mapping system to monitor geographically how much money is raised within certain geographic or jurisdictional limitations. In another embodiment, the system can determine fundraising activity. In one embodiment, these data can be illustrated graphically, such as via a mapping program. The geographic or jurisdictional breakdown can be any appropriate size, such as national, state, county, zip code, or the like. In other embodiments, the determination is made based on a collection of IP addresses.

In one embodiment, the central location creates a contribution web page through its software for campaign, federal, state, pac, organization or other generated by its superadministrator. However, this does not solve the problem for events that are held offline. For example when Hurricane Katrina hit many Americans wished to raise funds for the victims but where unable to unless provided a link to an existing contribution page. In one embodiment, the central location, allows donors not just campaigns to create events on behalf of campaigns and allows those campaigns to authorize them as approved events. This allows validation for donors to help raise money for their specific charity or event while maintaining control of event details such in a secure web format via ssl as: RSVP, EMAILS, DIRECTIONS, TIME, LOCATION, AMOUNT, AND ACCEPTING who can attend and who cannot.

In one embodiment, at least one directory categorizes donor generated events or fundraising opportunities. In one embodiment, the directory is maintained by the central location. The central location can aggregate campaigns, organizations, PACS, non profits to submit their event to the directory or allows them to register their campaign with the directory. Validation of identity is secured by appropriate techniques, such as fax, form, and validated with databases that prove PAC, CORPORATION, or 501 C3 or C4 status. For example, people are basically able to search for a cause and the search engine will aggregate these events by manual submission, spider or other events that are being generated by offline phone or mail ins to be added sot that a comprehensive directory is kept). In one embodiment, the compliance database generates event cards that conform to those specific laws. Campaigns can control the amounts to be raised, the time in which it to be raised, as well as the ability to publish attendees and share website and other external links on these event cards.

In one embodiment, the directory is accessible to the public and allow the public to post events from donors or supporters who wish to help a cause. For example, the events may get approved or may not get approved by the proposed sponsor. The funds then are sent via check, wire, or direct deposit to the appropriate organization, pac, or charity that has been certified by the CENTRAL LOCATION database and the information with be recorded in the e-donors profile. Multiple donors, finance committees, affiliates, supporter, volunteers, and/or activists can create an “event Card.” In one embodiment, the event card is dynamically generated and, in other embodiments, multiple templates are provided by event category like picnic, black tie, golf outing.

In one embodiment, the central location offers the ability to create, host, or attend a virtual fundraiser. In a virtual fundraiser, there is no meeting or physical event to attend, but there remains an opportunity to donate money to a campaign and/or cause. The users have the ability to purchase and electronic ticket. This ticket will be generated with appropriate information and then submitted by the admin to approve or not be approved by the event holder. If it is the ticket with contain proprietary or special information or information not made available to unapproved members to access the event by phone, text, video, web, or other communication vehicle. This information then will be sent via validated information and then trigger a response to the campaign that he or she has agreed to attend or not attend. In one embodiment, a reminder system will trigger the virtual fundraiser attendees that the event is happening and those who wish to publically validated their attendance, their information will be shared with other attendees to let them know they are participating.

This virtual fundraiser helps those campaigns who are unable to hold physical events invite others to participate via the internet and give the same behavior of buying a ticket to an event. The e-Ticket component also can be printed out and sent via a special feed to multiple printers. The API will allow the tickets information to be printed, private content written, personalized, enveloped, stamped, and mailed to any attendee.

In one embodiment, this information then for the Virtual Fundraiser allows certain tickets to be priced at certain value and then increased or decreased at the last moment. In one embodiment, a count down ticker to the event displays the time of the virtual fundraiser. In one embodiment, a user name and password to a special login can be given just for the event. In one embodiment, a web conference occurs and those attending may interact with those not physically attending or those attending may only interact with those virtually attending.

In one embodiment, the directory will list the virtual fundraiser and allows donors to buy an eticket from their own existing site or marketing scripts, or via search engine placement, or offline mechanisms.

In one embodiment, the central location system allows event card creators to set preferences on RSVP fields that dynamically can be generated along with multiple new fields or categories. This information will be sent by login or email to the event holder to be approved and then and only then will the e-ticket be issued.

In one embodiment, the e-ticket allows validates identity with government laws on raffling and makes sure it is compliant by generating a unique box at the bottom of the page that will have the campaign disclosure information that makes it compliant to every state. In one embodiment, the compliance is validated based on a call to the compliance database.

In one embodiment, the eticket is replaced by a special encoding that will tag the voter registration information in the account and display on e-ticket capability. In one embodiment, donor e-Tickets are tagged with validation. In one embodiment, every ticket is unique with information containing the identity of the ticket holder to be true. In one embodiment, information is validated by credit card transaction, voter database, central location databases, as well as campaign databases.

In one embodiment, information is generated via bar coding, or other scanning devices so that the event holder will have access to the e-tickets that are generated in excel format or other databases. This information will then deduct from the amount that the e-ticket event holder must give according the CENTRAL LOCATION databases legal compliance system. This will be added to the donor profile for reporting purposes, in one embodiment.

Additionally, all e-tickets purchased will also be accessible by the e-donor in their login giving them access to all their tickets and pass purchases. The system allows them to buy tickets before events and on advance notice. In one embodiment, the central location allows for events that are reoccurring. In one embodiment, preferences for attending, seating, or other information associated with preferences can be made in advance. This way campaigns can receive funds prior to events while still being compliant. In one embodiment, the central location allows a person to buy multiple tickets for campaigns in advance of the memorial celebration, while maintaining compliance with maximum donation limits. In one embodiment, such a feature enables compliance during big election years and give more money during that time. So in off years, you can purchase event tickets for the next 3 years.

This electronic ticketing system is unique to the campaign election industry because the ability to attend events, buy in advance, compliant with laws, validate identity, and then issuance and management with information of donor profile and be able to attend virtually.

In one embodiment, all donations are validated against a donor eligibility database to validate that the donor is eligible to donate. For example, certain jurisdictions may preclude non-citizens from donations, and in such a jurisdiction, the central location validates the purported donor against a list of citizens to validate the donor's eligibility to donate. Such a validation can reduce the instance of accepting a donation, only to be told at a later date that the donation was improper. In one embodiment, the central location validates eligibility by voter registration and then cross correlates previous donor behavior. Because for campaigns that are non political citizens will be still be able to give. This will help ensure that only citizens of the election system or actually investing into the campaigns and not foreigners.

In one embodiment, this system also allows those to register in the CENTRAL LOCATION database to do that by citizens overseas. In one embodiment, such a validation provides that voters with blocked IP addresses can still donate in accordance with their wishes despite their IP address. If they are validated by registration they will be able to give to a campaign through the central location. The campaigns can know that they are receiving valid information by the identity of that citizen cause it will validate identity with the appropriate CENTRAL LOCATION database engine of legal, compliance, and eligibility.

In one embodiment, the central location also has the ability to generate an event card page which modules can be added by the superadministrator. These features are controlled by the superadministrator. In one embodiment, payment processing and calculations are done by the superadministrator with the ability to create, delete, manage events, contributions, and monitor real time contributions coming in from the country.

In one embodiment, analytics that are generated can simulate past behavior of donors, times of donations, and make recommendations of when to solicit information and when not. For example, in the south, people do not like to give on Friday nights, but they like to give on Sundays, while in California people like to give on Friday. So user behavior is calculated, and used to solicit additional donations at a time when a likelihood of donation is deemed increased. In one embodiment, the central location provides the best recommendation to the campaigns of when to raise, how to raise and where to raise money.

In one embodiment, a mapping feature will display key information of those that give one time and those that are repeat donors. In one embodiment, the mapping feature reports the information by campaign, or by some other appropriate category. For example, the mapping feature can identify neighborhoods of higher donation levels as compared to neighborhoods of lower donation levels. Additionally, the mapping system can cross reference the donation levels against demographic information associated with the donations to determine additional information, such as neighborhoods that donate a higher proportion of average income levels, or the like. In one embodiment, the mapping system can assist a candidate determine where to hold a fundraiser.

In one embodiment, information for that fundraiser will be displayed in the central location where the information can be accessible to all donors via a public website. However, at the same time those that are registered as an e-donor in the central location system will be notified of an event that is happening. This information will be calculated not only by radius miles to the event, but type of event, and matching campaign event to donor profile. In one embodiment, these communications are targeted to those that would most likely come.

In one embodiment, the central location system has logic that will calculate the participation rate of attendees. In one embodiment, the central location also ranks attendees in the system so that campaigns can see who is more likely to come and who is not. In one embodiment, e-donors can increase their ranking by attending more events. In one embodiment, the central location databases match this information from event, campaign, donor and the directory so that a complete donor behavior and analytics can maximize participation and contribution.

In one embodiment, the central location provides a monthly donor program. Many membership organizations would like to accept periodic contributions online. However, the systems to accept these monthly contributions is difficult because credit card information can not be held in system unless the system is operated by a financial institution and certain privacy laws prohibit such maintenance by non-financial entities. In one embodiment, the central location includes a “lock” component that allows monthly contributions to take place at the date, time the first contribution has been received. In one embodiment, the central location can calculate the calendar year. The monthly contributions will be billed and the user information will lock up information that is compliant to federal and state laws and then bill by check, mail or credit card. The central location API will notify financial institution and the amount will be sent to the campaign. Compliance notification by email, mail, text etc. will be sent to the appropriate donor. And donor information will be collected in the e-donor account if the user has created one, or at a later date decides to open one. In one embodiment, the system tracks contributions on a timer that is compliant with various Federal, state and local laws, but also prohibits amounts greater or less than that those that can be given to political entities, or pacs, or organizations. For example, certain states will only allow a certain amount to be raised over a period of time. In one embodiment, the central location system will shut down the monthly system, take the contribution, suggest increased amounts.

In one embodiment, the central location determines an appropriate fund for a particular donation in response to a user profile. For example, donations from PAC entities are directed to certain funds, while individual donations are routed to other funds. In one embodiment, the donor identity is verified by consulting at least one online database, while in other embodiments, the verification is implemented off line.

As used herein, the term candidate and campaign are largely used interchangeably, wherein a campaign is a vehicle for a candidate to run for an elected office.

While the present invention has been described above in terms of specific embodiments, it is to be understood that the invention is not intended to be confined or limited to the preferred embodiments disclosed herein and that the scope of the present invention fully encompasses other embodiments which may become obvious to those skilled in the art. In addition, while specific component values have been show for ease of illustration and description, it should be understood that a variety of combination of values is possible and contemplated by the present invention. Further, while specific connections have been used and shown for ease of description, it should also be understood that a variety of connection points are possible and may vary depending on the specifics of the application and circuit used. These and all other such modifications and changes are considered to be within the scope of the appended claims and that the scope of the present invention is accordingly to be limited by nothing other than the appended claims.

We claim:

1. A method for facilitating communication between a candidate and at least one voter, the method comprising:
receiving at least one communication between the candidate and at least one voter;
determining at least one jurisdiction for the communication between the candidate and voter;
accessing a compliance database based on the determined jurisdiction;
determining at least one compliance rule responsive to the accessing;
comparing the received communication and compliance rule; and
facilitating the transmission of the communication between the candidate and at least one voter based on the comparison.

2. The method of claim 1 further comprising:
appending at least one compliance message to the received communication.

3. The method of claim 1 further comprising:
determining at least one compliance rule; and
adding the determined compliance rule to the compliance database.

4. The method of claim 1 wherein determining the at least one compliance rule responsive to the accessing comprises:
determining whether the compliance database includes at least one entry for the determined jurisdiction;
establishing the compliance rule based on the entry, if at least one entry exists; and
requesting entry of at least one compliance rule, if at least one entry does not exist in the compliance database.

5. The method of claim 1 further comprising:
determining at least one leader associated with at least one of the voters; and
notifying the leader based on the facilitation.

6. A method for facilitating donations from voters to campaigns, the method comprising:
establishing a campaign promoting the candidate for at least one office;
determining at least one leader for the campaign;
receiving at least one communication to at least one voter from the leader; and
facilitating at least one donation from the voter to the campaign.

7. The method of claim 6 further comprising:
associating the donation with the leader;
assigning a point value to the donation;
receiving a request for at least one item based on a sum of assigned point values; and
providing at least one item to the leader based on the received request and sum.

8. The method of claim 6 further comprising:
associating the donation with the voter;
assigning a point value to the donation;
receiving a request for at least one item based on a sum of assigned point values; and
providing at least one item to the voter based on the received request and sum.

9. A method for generating a dynamic web page, the method comprising:
receiving a page request;
determining at least one jurisdiction based on the page request;
accessing a compliance database based on the determined jurisdiction;
determining at least one compliance rule responsive to the accessing; and
generating the dynamic web page based on the determined compliance rule.

10. A method for collecting campaign donations for a campaign in a jurisdiction, the method comprising:
receiving a first donation from a voter;
determining the amount of the first donation;
determining a maximum donation amount based on the jurisdiction;
comparing the determined amount to the determined maximum donation;
accepting the first donation when the determined amount is less than the determined maximum donation;
receiving a second donation from the voter;
determining an amount of the second donation;
comparing a sum of the amount of the first donation and the amount of the second donation to the determined maximum donation; and
accepting the second donation with the sum is less than the determined maximum donation.

11. The method of claim 10 further comprising:
accessing a database storing records of prior donations;
determining an amount of prior donations by the voter; and
adding the amount of prior donations to the first donation prior to comparing the determined amount to the determined maximum donation.

12. The method of claim 10 further comprising:
transmitting a message based on accepting at least one of the first donation and second donation.

13. The method of claim 12 wherein transmitting the message comprises:
generating a printed note; and
mailing the printed note via a mail carrier.

14. The method of claim 10 further comprising:
rejecting at least one of the first donation and second donation based on the comparison; and
notifying the voter of the rejection.

15. The method of claim 10 further comprising:
displaying the determined maximum donation; and
notifying the voter that the first donation is less than the determined maximum donation based on the comparison.

16. A method for assisting the political process, the method comprising:
establishing a campaign promoting the candidate for at least one office;
receiving at least one communication between the candidate and at least one voter;
determining at least one jurisdiction for the communication between the candidate and voter;
accessing a compliance database based on the determined jurisdiction;
determining at least one compliance rule responsive to the accessing;
comparing the received communication and compliance rule;
facilitating the transmission of the communication between the candidate and at least one voter based on the comparison;
determining at least one leader for the campaign;
receiving at least one communication to at least one voter from the leader;
receiving a first donation from the voter;
determining the amount of the first donation;
determining a maximum donation amount based on the jurisdiction;
comparing the determined amount to the determined maximum donation;
accepting the first donation when the determined amount is less than the determined maximum donation;
receiving a second donation from the voter;
determining an amount of the second donation;
comparing a sum of the amount of the first donation and the amount of the second donation to the determined maximum donation; and
accepting the second donation with the sum is less than the determined maximum donation.
